(19) United States
(12) Patent Application Publication
(10) Pub. No.: US 2002/0084437 A1
(43) Pub. Date: Jul. 4, 2002

(54) Valve assembly for medical manifold

(76) Inventors: Todd S. Nitsche, Athens, TX (US); Michael C. Hamlin, Larue, TX (US); Rick Foster, Flint, TX (US); William R. Woods, Frankston, TX (US)

Correspondence Address: Bush Intellectual Property Law Group, LLC, P.O. Box 381146, Birmingham, AL, 35242, US

(21) Appl. No.: 10/020,400

(22) Filed: Dec. 12, 2001

Related U.S. Application Data
(60) Provisional application No. 60/255,009, filed on Dec. 12, 2000.

(51) Int. Cl. F16K 5/04

(52) U.S. Cl. 251/309; 251/297; 251/317; 251/904

(57) ABSTRACT

A valve member for use in a medical manifold valve assembly, wherein the valve member comprises a valve stem having a handle formed thereon for rotating the valve stem within the bore of a manifold. The valve stem has at least one pathway therethrough that can be aligned with channels through the manifold to allow fluid to flow through the valve stem pathway. The valve stem comprises at least two grooves circumscribing the valve stem, one groove above and one groove below each pathway opening. These grooves are preferably fitted or molded with a flexible material to form seals. The diameter of the valve stem above and below the area between the grooves is less than the diameter of the valve stem between the grooves such that the valve stem wall above and below the area between the grooves does not contact the bore wall. The frictional area between the valve stem wall and the bore wall is thereby reduced, making rotation of the valve stem much easier while still providing an adequate seal to prevent fluid leakage. The valve member preferably further comprises a detent feature to assist the operator in determining proper valve stem orientation.

### RELATED PATENT APPLICATION

This non-provisional patent application claims priority to U.S. Provisional Patent Application No. 60/255,009, filed Dec. 12, 2000, the entirety of which is incorporated herein by reference.

### FIELD OF THE INVENTION

The present invention relates to medical manifolds. More particularly, the present invention relates to an improved valve assembly for use in medical manifolds.

### BACKGROUND OF THE INVENTION

The use of medical manifolds is well known in the art. A medical manifold is typically an elongated member having one or more channels extending therethrough. The proximal end of the manifold typically has a coupling member for attachment to a peripheral device, such as a fluid source, wherein a manifold channel is in communication with the peripheral device through the proximal coupling member. The distal end of the manifold typically has another coupling member for attachment to a second peripheral device, such as a catheter, wherein a manifold channel is in communication with the second peripheral device through the distal coupling member. The manifold may have additional coupling members for attachment of various other devices. As used herein, the term “manifold” encompasses single and multiple port manifolds and stopcocks.

At each channel junction within the manifold, there is a valve assembly for regulating fluid communication through the manifold. Each valve assembly typically comprises a cylindrical bore in the manifold that is in communication with at least two channels. A cylindrical valve stem having a diameter that is slightly larger than the diameter of the bore is press fit into the bore, which forms a tight seal between the valve stem wall and the bore wall to prevent fluid from leaking from the manifold channels into the bore around the valve stem. The valve stem includes at least one pathway therethrough and a handle is typically formed on one end of the valve stem to allow an operator to orient the valve stem as desired. The valve stem must be rotated so that the pathway through the valve stem is aligned with the manifold channels to allow fluid to flow through the valve stem.

Two principal types of medical manifolds are low pressure and high-pressure manifolds. Low-pressure manifolds are used, for example, in manual syringe procedures. High-pressure manifolds are used in procedures requiring mechanical pressurization. Because fluids in a high-pressure manifold are under greater pressure, the valve stem wall must be tightly pressed against the bore wall to prevent fluid leakage from the manifold channels into the bore around the valve stem. As a result, valve stems in prior art high-pressure manifolds are very difficult to rotate due to the greater friction between the valve stem wall and the bore wall.

Accordingly, what is needed is a valve system for use in a high pressure medical manifold that requires less force to rotate the valve stem.

### SUMMARY OF THE INVENTION

The present invention is an improved valve member for use in a medical manifold valve assembly, wherein the valve member comprises a valve stem having a handle formed thereon for rotating the valve stem within the bore of a manifold. The handle preferably comprises a soft, flexible material for ergonomic comfort. The valve stem has at least one pathway therethrough that can be aligned with channels through the manifold to allow fluid to flow through the valve stem pathway. The valve stem comprises at least two grooves circumscribing the valve stem, one groove above and one groove below each pathway opening. These grooves are preferably fitted or molded with a flexible material to form seals. The diameter of the valve stem above and below the area between the grooves is less than the diameter of the valve stem between the grooves such that the valve stem wall above and below the area between the grooves does not contact the bore wall. The frictional area between the valve stem wall and the bore wall is thereby reduced, making rotation of the valve stem much easier for the operator while still providing an adequate seal to prevent fluid leakage from the manifold channels into the bore around the valve stem. The valve member preferably further comprises a detent feature to assist the operator in determining proper valve stem orientation, which is particularly helpful in low-light conditions.

Other features and advantages of the present invention will become apparent from the following detailed description and the appended drawings.

### BRIEF DESCRIPTION OF THE DRAWINGS

A valve member embodying features of the invention is described in the accompanying drawings which form a portion of this disclosure and wherein:

FIG. 1 is an elevational view of a prior art valve stem and handle.

FIG. 2 is a partial sectional view of a prior art valve assembly illustrating the prior art valve stem of FIG. 1 within a medical manifold.

FIG. 3 is an elevational view of the valve stem and handle of the present invention.

FIG. 4 is a partial sectional view of a valve assembly illustrating the valve stem of FIG. 3 within a medical manifold.

FIG. 5 is an enlarged sectional view of the valve stem of FIG. 4.

FIG. 6 is a perspective view of an alternate embodiment of the present invention.

FIG. 7 is an exploded perspective view of the embodiment of FIG. 6.

FIG. 8 is an enlarged sectional view of another alternate embodiment of the present invention.

### DETAILED DESCRIPTION OF THE PREFERRED EMBODIMENTS

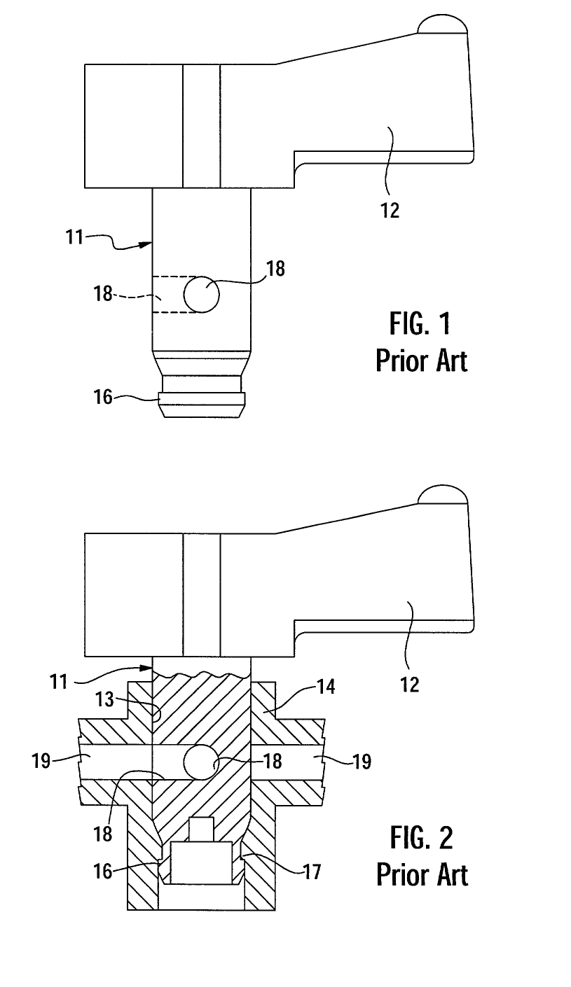

A more complete understanding of the invention may be obtained by reference to the accompanying drawings. To better understand the novel features of the present invention, a prior art valve stem is illustrated in FIGS. 1 and 2, wherein the valve stem 11 has a handle 12 at one end for rotating the valve stem within a cylindrical bore 13 of a medical manifold 14. The lower end of the valve stem 11 includes an annular flange 16 that slides over and engages an annular flange 17 in the manifold 14 to secure the valve stem within the manifold. The valve stem 11 includes a 3-way pathway 18 therethrough that can be aligned with channels 19 within the manifold 14 so that fluid (i.e. gas or liquid) can flow through the valve stem. The outer diameter of the valve stem 11 is slightly larger than the diameter of the bore 13 along the entire length thereof such that the valve stem wall and bore wall are frictionally engaged along the entire length of their respective surfaces. As a result, the valve stem is very difficult to rotate.

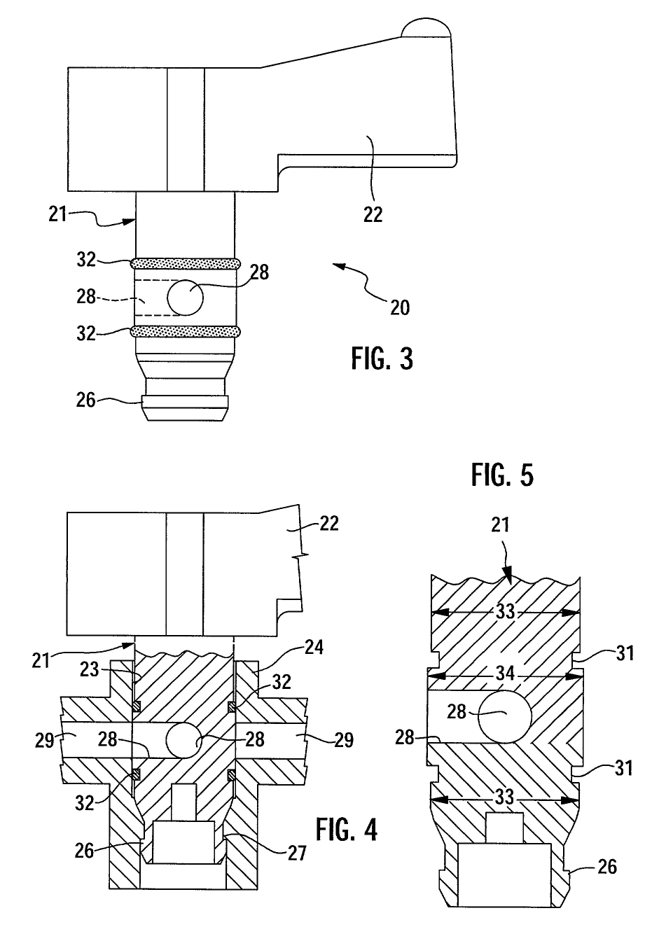

According to the preferred embodiment illustrated in FIGS. 3-5, the present invention is a valve member 20 for use in a medical manifold valve assembly, wherein the valve member 20 comprises a valve stem 21 having a handle 22 formed thereon for rotating the valve stem within the bore 23 of a manifold 24. The lower end of the valve stem 21 preferably includes an annular flange 26 that slides over and engages an annular flange 27 in the manifold 24 to secure the valve stem within the manifold. The valve stem 21 has at least one pathway 28 therethrough than can be aligned with channels 29 through the manifold 24 to allow fluid to flow through the valve stem pathway.

The valve stem 21 comprises at least two grooves 31 circumscribing the valve stem, at least one groove above and one groove below each pathway opening. These grooves 31 are fitted with flexible seals 32. Alternatively, grooves 31 and seals 32 can be substituted with annular ridges formed either on the valve stem or on corresponding positions within the manifold bore. The diameter of the valve stem 21 above and below the area between the seals 32 (designated by 33) is preferably less than the diameter of the valve stem between the seals (designated by 34) such that diameter 33 does not contact the wall of the bore 23. The frictional area between the wall of the valve stem 21 and the wall of the bore 23 is thereby reduced, making rotation of the valve stem much easier for the operator while still providing an adequate seal to prevent fluid leakage from the manifold channels 29 into the bore 23 around the valve stem 21.

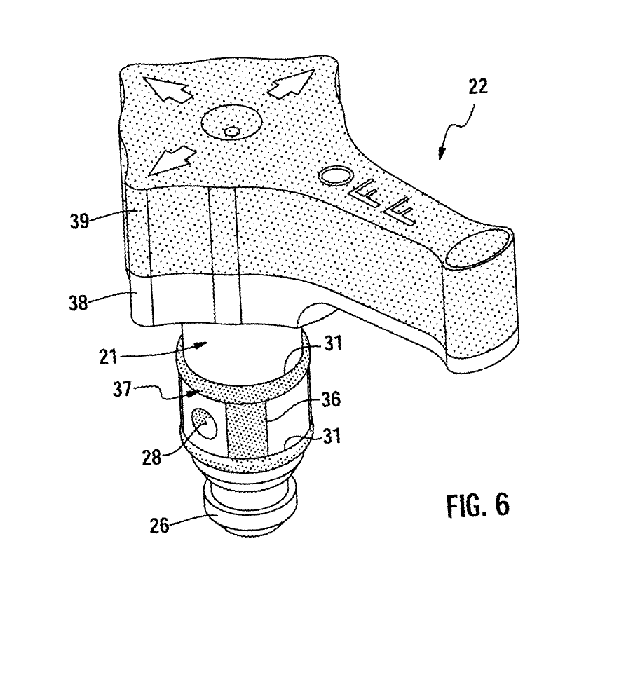

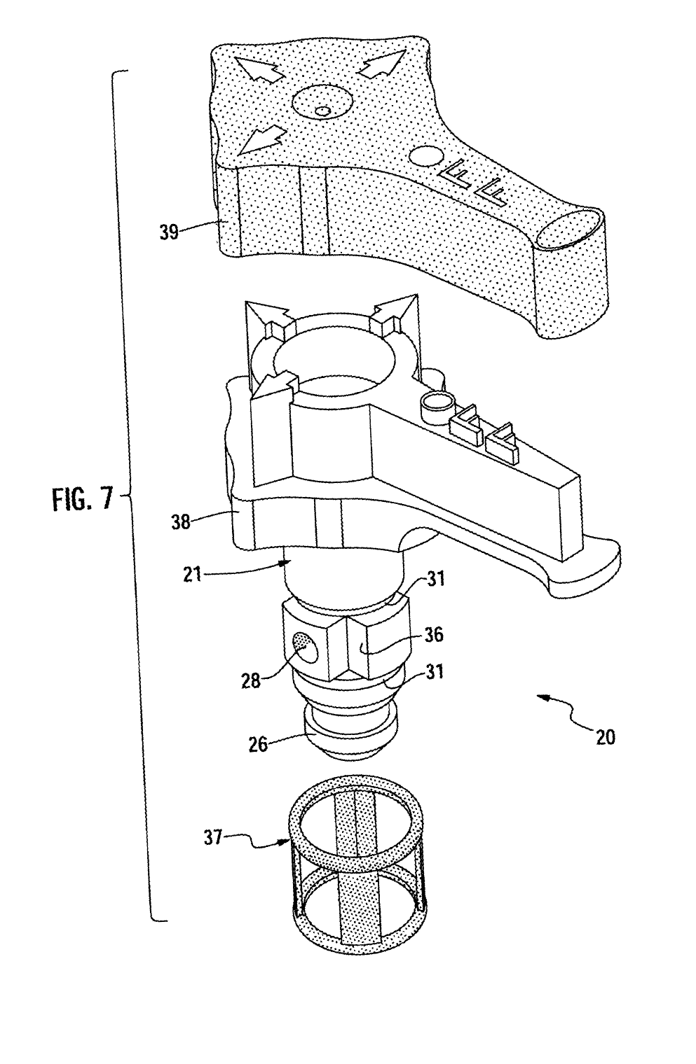

In an alternate embodiment shown in FIGS. 6-7, the valve stem 21 comprises at least two “horizontal” grooves 31 circumscribing the valve stem, at least one groove above and one groove below each pathway opening. The valve stem 21 further comprises at least two “vertical” grooves 36 intersecting the horizontal grooves, at least one vertical groove 36 on each side of each pathway opening. These grooves 31, 36 are fitted with a multiple seal member 37 having horizontal and vertical components. Alternatively, grooves 31, 36 and multiple seal member 37 can be substituted with ridges formed either on the valve stem or on corresponding positions within the manifold bore. The handle 22 is preferably formed by two mating sections: a rigid member 38 preferably molded to the valve stem 21; and a soft, flexible member 39 for ergonomic comfort.

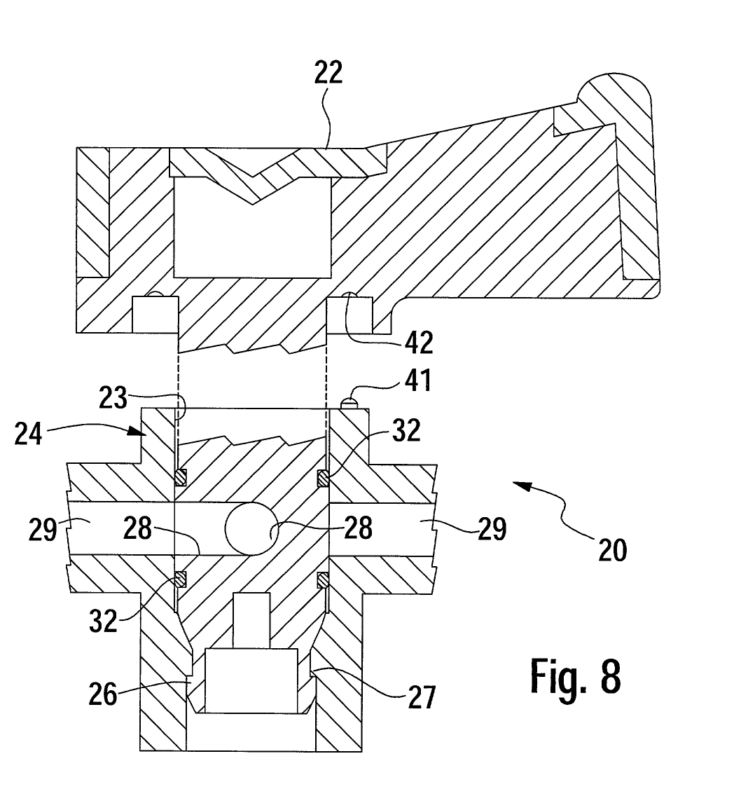

In another alternate embodiment shown in FIG. 8, the valve member 20 includes one or more detents to assist the operator in determining proper valve stem 21 orientation, which is particularly helpful in low-light conditions. Each detent is preferably a convex member 41 formed along the top surface of the manifold 24. The underside of the handle 22 preferably includes one or more concave formations 42 such that as the valve stem 21 is rotated, the underside of the handle 22 slides over the detent 41 until a concave formation 42 engages the detent, thereby indicating that the valve stem is in a proper predetermined alignment. While the detent feature has been described in one form, it should be understood that the detent feature could take numerous forms.

The valve assembly of the present invention can withstand the increased pressure associated with pressurized procedures utilizing high-pressure manifolds, yet the valve member 20 only requires a relatively small amount of torque to rotate the valve stem 21. High-pressure manifolds currently available must maintain 500 static psi, at which the torque required to rotate the valve stem is near or above 28 ounces/inch (oz/in), which is difficult to accomplish with a single hand. Tests of the present invention indicate that the torque required to rotate the valve stem is relatively low in a high-pressure rated system. Accordingly, the present invention finds application in both low-pressure and high-pressure manifolds.

Although the invention has been described in various forms, it should be understood that the invention is not so limited but is susceptible of various changes and modifications without departing from the sprit thereof.

1. A valve member for use in a medical manifold valve assembly, comprising:
a. a cylindrical valve stem having a pathway therethrough, wherein said pathway has at least two openings along a peripheral surface of said valve stem, wherein each of said openings is flanked between annular seals circumscribing said valve stem, wherein said annular seals are raised above said peripheral surface of said valve stem; and
b. means for rotating said valve stem within the manifold.

2. A valve member according to claim 1, wherein each of said annular seals comprises a flexible material fitted within an annular groove circumscribing said valve stem.

3. A valve member according to claim 2, wherein each of said openings is further flanked between longitudinal seals connecting said annular seals such that each of said openings is bordered on four sides by said longitudinal seals and said annular seals, wherein said longitudinal seals are raised above said peripheral surface of said valve stem.

4. A valve member according to claim 3, wherein each of said longitudinal seals comprises a flexible material fitted within a longitudinal groove connecting said annular grooves.

5. A valve member according to claim 1, further comprising means formed on a distal end of said valve stem for securing said valve stem within the manifold.

6. A valve member according to claim 1, wherein said rotating means is a handle affixed to a proximal end of said valve stem, wherein said handle comprises a soft, flexible material for ergonomic comfort.

7. A valve member according to claim 1, wherein said valve stem comprises a first diameter located between said annular seals and a second diameter adjacent each side of said first diameter, wherein said first diameter is greater than said second diameter.

8. A valve member for use in a medical manifold valve assembly, comprising:
a. a cylindrical valve stem having a pathway therethrough, wherein said pathway has at least two openings along a peripheral surface of said valve stem, wherein said valve stem comprises a first diameter encompassing said pathway openings and a second diameter adjacent each side of said first diameter, wherein said first diameter is greater than said second diameter; and
b. means for rotating said valve stem within the manifold.

9. A medical apparatus, comprising:
a. a manifold having first and second ends, a cylindrical bore extending between said first and second ends, and at least two channels extending through said manifold and intersecting said bore wherein each of said channels has an opening along a peripheral surface of said bore;
b. means for regulating fluid communication through said bore, said regulating means comprising a cylindrical member mounted within said bore for rotation therein, said cylindrical member having at least one pathway therethrough wherein said pathway has at least two openings along a peripheral surface of said cylindrical member, wherein said channels are in communication through said bore only when said pathway openings are suitably rotated for alignment with said channel openings; and
c. means for sealing the junctions between said pathway openings and said channel openings to prevent leakage of fluid into said bore about said cylindrical member, wherein said sealing means comprises a seal member circumscribing each of said junctions.

10. A medical apparatus according to claim 9, wherein each of said seal members is formed on the surface of said bore circumscribing each of said channel openings, wherein each of said seal members is raised above said surface of said bore.

11. A medical apparatus according to claim 10, wherein each of said seal members comprises a flexible material fitted within a groove circumscribing each of said channel openings.

12. A medical apparatus according to claim 9, wherein each of said seal members is formed on the surface of said cylindrical member circumscribing each of said pathway openings, wherein each of said seal members is raised above said surface of said cylindrical member.

13. A medical apparatus according to claim 12, wherein each of said seal members comprises a flexible material fitted within a groove circumscribing each of said pathway openings.

14. A medical apparatus according to claim 9, wherein said regulating means further comprises a handle extending beyond said first end of said manifold for rotating said cylindrical member.

15. A medical apparatus according to claim 14, wherein said handle comprises a soft, flexible material for ergonomic comfort.

16. A medical apparatus according to claim 14, further comprising at least one detent to assist a user in aligning said pathway openings and said channel openings.

17. A medical apparatus according to claim 16, wherein said at least one detent comprises a protruding member formed on said first end of said manifold, wherein said protruding member engages one or more concave formations formed on an underside of said handle as said cylindrical member is rotated within said bore.

18. A medical apparatus, comprising:
a. a manifold having first and second ends, a cylindrical bore extending between said first and second ends, and at least two channels extending through said manifold and intersecting said bore, wherein each of said channels has an opening along a peripheral surface of said bore; and
b. means for regulating fluid communication through said bore, said regulating means comprising a cylindrical member mounted within said bore for rotation therein, said cylindrical member having at least one pathway therethrough wherein said pathway has at least two openings along a peripheral surface of said cylindrical member, wherein said channels are in communication through said bore only when said pathway openings are suitably rotated for alignment with said channel openings, wherein said cylindrical member comprises a first diameter encompassing said pathway openings and a second diameter adjacent each side of said first diameter, wherein said first diameter is greater than said second diameter such that said first diameter forcibly engages a peripheral surface of said bore to prevent leakage of fluid into said bore about said cylindrical member, and said second diameter does not contact said peripheral surface of said bore.

19. A medical apparatus according to claim 18, further comprising means for sealing the junctions between said pathway openings and said channel openings to prevent leakage of fluid into said bore about said cylindrical member.

20. A medical apparatus according to claim 19, wherein said sealing means comprises a seal member circumscribing each of said junctions.

21. A medical apparatus according to claim 20, wherein each of said seal members is formed on the surface of said bore circumscribing each of said channel openings, wherein each of said seal members is raised above said surface of said bore.

22. A medical apparatus according to claim 20, wherein each of said seal members is formed on the surface of said cylindrical member circumscribing each of said pathway openings, wherein each of said seal members is raised above said surface of said cylindrical member.

23. A medical apparatus according to claim 19, wherein said sealing means comprises an annular seal circumscribing said cylindrical member on opposing sides of each of said pathway openings, wherein said annular seals are raised above said peripheral surface of said cylindrical member.

24. A medical apparatus according to claim 23, wherein said sealing means further comprises a longitudinal seal connecting said annular seals on opposing sides of each of said pathway openings such that each of said pathway openings is bordered on four sides by said longitudinal seals and said annular seals.

25. A medical apparatus according to claim 19, wherein said sealing means comprises an annular seal circumscribing said bore on opposing sides of each of said channel openings, wherein said annular seals are raised above said peripheral surface of said bore.

26. A medical apparatus according to claim 25, wherein said sealing means further comprises a longitudinal seal connecting said annular seals on opposing sides of each of said channel openings such that each of said channel openings is bordered on four sides by said longitudinal seals and said annular seals.
